(19) United States
(12) Patent Application Publication
(10) Pub. No.: US 2026/0280902 A1
(43) Pub. Date: Sep. 17, 2026

(54) CERTIFICATE ISSUING FOR VIRTUAL NETWORK FUNCTIONS

(71) Applicant: TELEFONAKTIEBOLAGET LM ERICSSON (PUBL), STOCKHOLM (SE)

(72) Inventors: Bernard Smeets, Lund (SE); Anu Puhakainen, Jorvas (FI); Harri Hakala, Turku (FI); Juha Sääskilahti, Jorvas (FI); Kari-Pekka Perttula, Jorvas (FI); Mikael Eriksson, Göteborg (SE)

(21) Appl. No.: 18/875,716

(22) PCT Filed: Jun. 9, 2023
(86) PCT No.: PCT/EP2023/065465

§ 371 Date: Dec. 16, 2024

Related U.S. Application Data
(60) Provisional application No. 63/352,596, filed on Jun. 15, 2022.

(51) Int. Cl. H04L 9/32; H04L 9/30

(52) U.S. Cl. CPC H04L 9/3268; H04L 9/3073

(57) ABSTRACT

There is provided techniques for a VNF node to obtain a certificate. A method is performed by the VNF node. The method comprises generating and storing an identifier string of the VNF node inside a TEE of the VNF node. The method comprises providing the identifier string towards a certificate broker node. The method comprises providing a quote towards an attest verifier node upon having obtained a session value from the attest verifier node. The quote is based on the session value and comprises the identifier string or a hash of the identifier string. The method comprises obtaining configuration from the certificate broker node for enrollment of the certificate with a certificate registration authority node. The method comprises obtaining the certificate from the certificate registration authority node in accordance with the configuration.

### TECHNICAL FIELD

Embodiments presented herein relate to a method, a virtual network function node, a computer program, and a computer program product for the virtual network function node to obtain a certificate. Embodiments presented herein further relate to a method, a certificate broker node, a computer program, and a computer program product for assigning a certificate to the virtual network function node.

### BACKGROUND

Network functions of cellular communication networks as specified by the third generation partnership project (3GPP) for use in fourth generation (4G) and fifth generation (5G) telecommunication systems are commonly realized as virtual network functions (VNFs). Here, the attribute virtual expresses that the network functions are not implemented by a set of programs executing on a given specific device, but rather are implemented by programs that execute on a virtual device. In this respect, the virtual device is realized by virtual machine or container technologies. The Service-Based Architecture (SBA) has been developed to bring the benefits of VNFs to 3GPP cellular communication networks.

Whilst virtualization and container technologies bring many benefits, the implied separation of the network functions and the device where they execute also raises concerns and new issues. One approach taken to mitigate the risks that a network is built that is without trustworthy network functions is the ubiquitous use of secure network protocols, such as the Transport Layer Security (TLS) protocol, to realize the required connections between the VNFs. But this requires a more extensive use of certificates compare to previously generations of telecommunication systems. In addition, private keys associated with certificates (which are identities that bind a secret kept by, say a TLS server or client, to issued identifiers) are securely kept inside the VNFs.

Not only are more certificates needed in an SBA system, but due to the automated scaling of the functional instances of VNFs and inside an VNF, the certificate life-cycle management has to match the dynamics of the operational situation of the functional instances that provide the networking interfaces needed to get certificates issued, either as new instances of VNFs or as replicas of existing VNFs during runtime.

A classical approach to assign certificates to a client (such as a VNF) is based on the pre-existence of a procedure that identifies the TLS server or client. Procedures here mimic the assignment of a password to a person based on a pre-existing identity of that person. This paradigm is not usable for VNFs as each VNF is just a dynamically created set of executing programs of which multiple copies can be created. In practice, a unique identifier is usually assigned to the created instance (such as a VNF) when the instance is orchestrated. But, then the binding of the certificate is entirely depending on the trust of the orchestration, and it is impossible to distinguish an erroneous start of copies of the VNF or the start of a VNF from a backup of the original VNF.

### SUMMARY

An object of embodiments herein is to address the above issues.

According to a first aspect there is presented a method for a VNF node to obtain a certificate. The method is performed by the VNF node. The method comprises generating and storing an identifier string of the VNF node inside a TEE of the VNF node. The method comprises providing the identifier string towards a certificate broker node. The method comprises providing a quote towards an attest verifier node upon having obtained a session value from the attest verifier node. The quote is based on the session value and comprises the identifier string or a hash of the identifier string. The method comprises obtaining configuration from the certificate broker node for enrollment of the certificate with a certificate registration authority node. The method comprises obtaining the certificate from the certificate registration authority node in accordance with the configuration.

According to a second aspect there is presented a VNF node for obtaining a certificate. The VNF node comprises processing circuitry. The processing circuitry is configured to cause the VNF node to generate and store an identifier string of the VNF node inside a TEE of the VNF node. The processing circuitry is configured to cause the VNF node to provide the identifier string towards a certificate broker node. The processing circuitry is configured to cause the VNF node to provide a quote towards an attest verifier node upon having obtained a session value from the attest verifier node. The quote is based on the session value and comprises the identifier string or a hash of the identifier string. The processing circuitry is configured to cause the VNF node to obtain configuration from the certificate broker node for enrollment of the certificate with a certificate registration authority node. The processing circuitry is configured to cause the VNF node to obtain the certificate from the certificate registration authority node in accordance with the configuration.

According to a third aspect there is presented a VNF node for obtaining a certificate. The VNF node comprises a generate and store module configured to generate and store an identifier string of the VNF node inside a TEE of the VNF node. The VNF node comprises a provide module configured to provide the identifier string towards a certificate broker node. The VNF node comprises a provide module configured to provide a quote towards an attest verifier node upon having obtained a session value from the attest verifier node. The quote is based on the session value and comprises the identifier string or a hash of the identifier string. The VNF node comprises an obtain module configured to obtain configuration from the certificate broker node for enrollment of the certificate with a certificate registration authority node. The VNF node comprises an obtain module configured to obtain the certificate from the certificate registration authority node in accordance with the configuration.

According to a fourth aspect there is presented a computer program for a VNF node to obtain a certificate, the computer program comprising computer program code which, when run on processing circuitry of a VNF node, causes the VNF node to perform a method according to the first aspect.

According to a fifth aspect there is presented a method for assigning a certificate to a VNF node. The method is performed by a certificate broker node. The method comprises obtaining an identifier string of the VNF node from the VNF node. The method comprises initiating attestation of the VNF node by sending the identifier string to an attest verifier node and requesting the attest verifier node to send a session value towards the VNF node. The method comprises obtaining an indication of successful attestation of the VNF node from the attest verifier node. The method comprises requesting the certificate for the VNF node by registering the VNF node with a certificate registration authority node. The method comprises providing the VNF node with configuration for enrollment of the certificate.

According to a sixth aspect there is presented a certificate broker node for assigning a certificate to a VNF node. The certificate broker node comprises processing circuitry. The processing circuitry is configured to cause the certificate broker node to obtain an identifier string of the VNF node from the VNF node. The processing circuitry is configured to cause the certificate broker node to initiate attestation of the VNF node by sending the identifier string to an attest verifier node and requesting the attest verifier node to send a session value towards the VNF node. The processing circuitry is configured to cause the certificate broker node to obtain an indication of successful attestation of the VNF node from the attest verifier node. The processing circuitry is configured to cause the certificate broker node to request the certificate for the VNF node by registering the VNF node with a certificate registration authority node. The processing circuitry is configured to cause the certificate broker node to provide the VNF node with configuration for enrollment of the certificate.

According to a seventh aspect there is presented a certificate broker node for assigning a certificate to a VNF node. The certificate broker node comprises an obtain module configured to obtain an identifier string of the VNF node from the VNF node. The certificate broker node comprises an initiate module configured to initiate attestation of the VNF node by sending the identifier string to an attest verifier node and requesting the attest verifier node to send a session value towards the VNF node. The certificate broker node comprises an obtain module configured to obtain an indication of successful attestation of the VNF node from the attest verifier node. The certificate broker node comprises a request module configured to request the certificate for the VNF node by registering the VNF node with a certificate registration authority node. The certificate broker node comprises a provide module configured to provide the VNF node with configuration for enrollment of the certificate.

According to an eighth aspect there is presented a computer program for assigning a certificate to a VNF node, the computer program comprising computer program code which, when run on processing circuitry of a certificate broker node, causes the certificate broker node to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects provide a secure binding of a certificate given to a VNF node that guarantees uniqueness of the binding to the VNF node.

Advantageously, these aspects prevent a VNF node that has become malicious to impersonate other VNF nodes.

Advantageously, these aspects enable secure automation of certificate issuing to VNF nodes.

Advantageously, these aspects enable coordination of life-cycle management of the VNF node and certificates used by the VNF node.

Other objectives, features and advantages of the enclosed embodiments will be apparent from the following detailed disclosure, from the attached dependent enumerated claims as well as from the drawings.

Generally, all terms used in the list of enumerated claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic block diagram according to examples;

FIGS. 2 and 3 are flowcharts of methods according to embodiments;

FIGS. 4, 5, and 6 are schematic block diagrams according to embodiments;

FIG. 7 is a signaling diagram according to an embodiment;

FIG. 8 is a schematic diagram showing functional units of a VNF node according to an embodiment;

FIG. 9 is a schematic diagram showing functional modules of a VNF node according to an embodiment;

FIG. 10 is a schematic diagram showing functional units of a certificate broker node according to an embodiment;

FIG. 11 is a schematic diagram showing functional modules of a certificate broker node according to an embodiment; and

FIG. 12 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

The wording that a certain data item, piece of information, etc. is obtained by a first device should be construed as that data item or piece of information being retrieved, fetched, received, or otherwise made available to the first device. For example, the data item or piece of information might either be pushed to the first device from a second device or pulled by the first device from a second device. Further, in order for the first device to obtain the data item or piece of information, the first device might be configured to perform a series of operations, possible including interaction with the second device. Such operations, or interactions, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the first device.

The wording that a certain data item, piece of information, etc. is provided by a first device to a second device should be construed as that data item or piece of information being sent or otherwise made available to the second device by the first device. For example, the data item or piece of information might either be pushed to the second device from the first device or pulled by the second device from the first device. Further, in order for the first device to provide the data item or piece of information to the second device, the first device and the second device might be configured to perform a series of operations in order to interact with each other. Such operations, or interaction, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the second device.

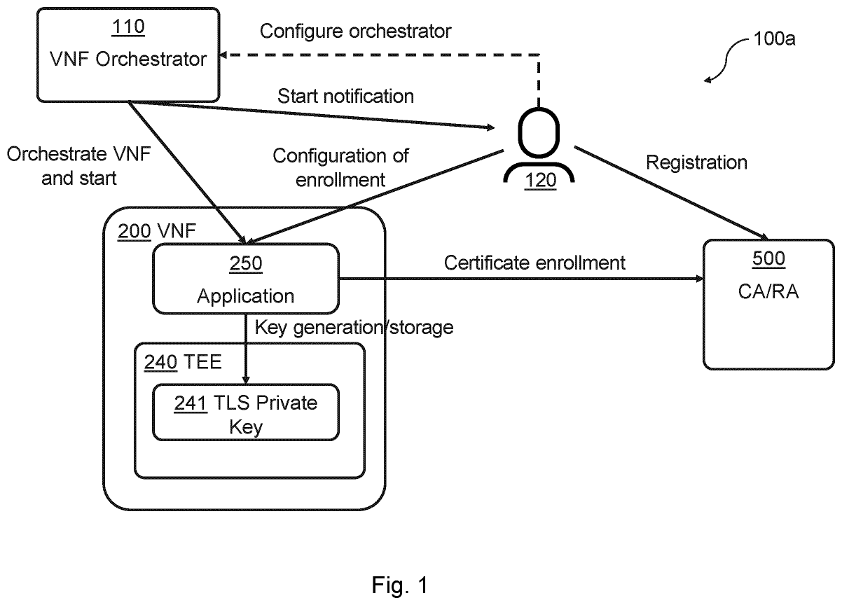

An example reference method for a VNF node to obtain a certificate from a certificate registration authority (CA/RA) node via enrollment will be disclosed next with reference to the schematic block diagram 100a of FIG. 1. A VNF operator 120 configures a VNF orchestrator 110 with information of a VNF node 200. The VNF orchestrator 110 initiates VNF orchestration and deployment and starts the VNF node 200. The VNF operator 120 is by the VNF orchestrator 110 notified of the start of the VNF node 200. Once the VNF node 200 is started, and application 250 executed in the VNF node 200 initiates generation and storage of a private-public key pair 241 for TLS in a trusted execution environment (TEE) 240. The VNF operator 120 registers information of the VNF node 200 in a certificate registration authority node 500 and receives information to be used when executing a certificate enrollment protocol. The VNF operator 120 configures the application 250 with the information needed for enrollment. The application 250 executes the certificate enrolment protocol with the certificate registration authority node 500 and receives a TLS certificate from the certificate registration authority node 500.

Some issues with assigning certificates to a VNF node 200, such as the example reference method in FIG. 1, have been disclosed above.

Allowing a VNF to autonomously fetch a certificate with arbitrary content from a CA could allow a malicious party to easily craft fake certificates by utilizing the same authentication as the legitimate VNFs. Hence the ability of fetching a certificate must stay under control. The aforementioned procedure that identifies the TLS server or client can be an initial level of authentication e.g. using a common shared password, or proof of possession such as DNS entry.

Further in this respect, existing techniques for certificate management of certificates for external interfaces on cloud native functions (CNFs) realizing a VNF node 200 require the VNF operator 120 to interact first with the certificate registration authority node 500 to register the VNF node 200 that correspond to the instance interfaces for which certificates have to be provided. Each VNF node 200 is uniquely identified through a credential, such as a one-time password, which the VNF operator 120 must feed into the CNF as day-o (start-up) configuration or via online initialization. This is a cumbersome and error prone process.

Furthermore, the public key infrastructure (PKI) of the certificate registration authority node 500 that manages the issued certificates is not designed to manage the end-entities as grouped per CNF. Instead, the certificate registration authority node 500 manages them as separate items. This makes it error-prone to properly life-cycle manage collectively the certificates of a CNF/VNF which may have, for example, have multiple server certificates for its different service providing interfaces.

Furthermore, in the context of 5G telecommunication systems where the Network Repository Function (NRF) maintains the discovery functions over all network functions, the NRF information needs to be synchronized with PKI management, which is not the case today.

Furthermore, while existing certificate management functions may rely on the certificate registration authority node 500 to register entities and vouch for the certificate requester's identity, existing certificate management techniques fall back to manual procedures which scale poorly in cloud computing environments where VNF orchestrators 110 have replaced manual actions and oversight and trust relations.

Furthermore, in some cellular communication networks, such as 5G telecommunication systems, there is a high dynamicity with changing fully qualified domain names (FQDNs) that cause certificate information to become not usable and new certificates have to be created. Existing certificate management systems have no awareness of these aspects of changes.

The embodiments disclosed herein aim at addressing at least some of these issues.

The embodiments disclosed herein in particular relate to techniques for a VNF node 200 to obtain a certificate and for a certificate broker node 300 to assign a certificate to a VNF node 200. In order to obtain such techniques there is provided a VNF node 200, a method performed by the VNF node 200, a computer program product comprising code, for example in the form of a computer program, that when run on processing circuitry of the VNF node 200, causes the VNF node 200 to perform the method. In order to obtain such techniques there is further provided a certificate broker node 300, a method performed by the certificate broker node 300, and a computer program product comprising code, for example in the form of a computer program, that when run on processing circuitry of the certificate broker node 300, causes the certificate broker node 300 to perform the method.

In some aspects, there is disclosed an attestable environment in a network function instance (such as a VNF node 200) that can provide an identifier that can be bound to the network function instance (as a collection of uniquely existing processes).

The example of TLS servers and clients is used to illustrate some principles of the herein disclosed embodiments, but the present disclosure is equally applicable to Hypertext Transfer Protocol Secure (HTTPS), Internet Protocol Security (IPsec), Internet Key Exchange (IKE), and other secure transport/communication protocols that use certificates.

In general terms, instead of artificially gluing a certificate to a server or client instance in a VNF node 200, when the VNF node 200 is started it lacks a certificate. The VNF node 200 will therefore start a procedure to obtain a certificate. A first step in this procedure is the generation of a private-public keypair, for example generated according to an asymmetric cryptographic scheme, such as the Rivest-Shamir-Adleman (RSA) algorithm or the Elliptic Curve Digital Signature Algorithm (ECDSA). To have a secure protection of the private key of this private-public keypair, the VNF node 200 may use a range of techniques to isolate the private key from general parts of the code (called hereafter application code) stored and executed on the VNF node 200. Software based approaches give an approved separation between application code and the code and storage for the keys. However, improved separation is provided by TEEs realized by different types of security hardware. Some non-limiting examples of TEEs are ARM TrustZone, Intel SGX, and AMD SEV technologies. TEE technologies are also referred to as hardware based confidential compute technologies. There also exist hybrid technologies where the security hardware. such as a Trusted Computing Group (TCG) Trusted Platform Module (TPM), is providing a hardware root of trust and where the operating system Kernel functions are augmented to security functions with separation capabilities. Further, a dedicated Hardware Security Module (HSM) may provide the secure storage, or virtual TPM functionality for the software. Without loss of generality, the security hardware will hereinafter be represented by a TEE.

In general terms, the TEE is provided with a protected hardware identity. This identity could directly be used in a certificate issuing process. For example, for a TPM an Attestation Key (AK) is logically tied to a TPM persistent key (e.g., an Endorsement Key). Although this might work in theory, in practice the detailed identity management of hardware in a datacenter is implemented as a cloud service, or infrastructure provider task, which the users (called tenants) of the cloud infrastructure are not involved in. Indeed, one purpose of the cloud service is to relieve the tenant from handling hardware related details. From the tenant perspective it is sufficient to know, and being able to verify, that the hardware is uncompromised. Knowing the exact identity of the hardware is not needed by the tenant. The tenant only needs to obtain evidence that the hardware is secure.

Although the tenant is not interested in the hardware identity itself, the tenant thus requires information if the secure hardware and the software stored therein is trustworthy. Towards this end, the secure hardware provides a mechanism called attestation where the combination of hardware and software (firmware) will collect information of the secure hardware, comprising a measurement of the loaded software, and is able to send in secure manner that information to a (remote) verifier operated by the tenant. The latter is often a signed (by the hardware identity) fingerprint of the data representing that information. By using a vendor certificate containing the public key of the secure hardware it is simple for a verifier to check the signature; the verifier will accept signatures generated by any secure hardware of the vendor systems. The signed message is referred to as quote. Commonly, the quote is created on request by the verifier.

Instead of binding the certificate to an identifier that the VNF orchestrator 110 associates with a starting VNF node 200, it is the TEE 240 inside the VNF node 200 that creates this identifier and signs the identifier with a key that the tenant knows is inside the TEE 240. This key could be defined by the original hardware identity but could possibly alternatively be a key that was created inside the TEE 240 and linked to the hardware identity. To secure temporal uniqueness, the signature might bind the identifier not only to the TEE 240 but also to a unique session in which the verifier interacts with the TEE 240. This prevents that the verifier is presented with replays of the identifier. Hence, the signature should cover a non-predictable input to the signing process that the verifier sends prior to the signing process of the identifier. This will hereinafter be referred to as a session value.

In the case the certificate registration authority node 500 is also in the tenant domain the validations of the verifier of the received identifier can be used by the certificate registration authority node 500.

Protocols for certificate enrollment like Certificate Management Protocol version 2 (CMPv2), Enrolment over Secure Transport (EST), Automatic Certificate Management Environment (ACME), or similar, or even proprietary, use mechanisms by which the VNF node 200, often called end-entity, that requests the certificate is bound to a created instance, here called an account, inside the certificate registration authority node 500 The purpose of the account binding is to assure that the issued certificate is coupled to a specific VNF node 200. In this account creation, the contents of the to-be-requested certificate can be fixed, so that the CA will return the specified content, regardless what is requested in the CSR from the VNF in the certificate request. As explained earlier, a classical certificate registration authority node 500 use out-of-band procedures to create such accounts.

The herein disclosed embodiments are based on the use of a certificate broker node 300. The certificate broker node 300 will be triggered by a request of the VNF node 200 performing an account registration. When doing this, the certificate broker node 300 will obtain the identifier of the VNF node 200 and uses an attest verifier node 400 to check that this identifier is indeed properly created in a TEE 240, or alternatively obtains the identifier directly from the attest verifier node 400, whatever is most appropriate in a specific realization.

The verified identifier is not registered by the certificate broker node 300 into the created account. In case of the CMPv2 protocol is used, the certificate registration authority node 500 and certificate broker node 300 agree on a one-time password (OTP) that the application 250 later can use to request a certificate, and the certificate broker node 300 provides this OTP securely to the VNF node 200. It is at this point the VNF node 200 can create its private-public key pair, create a certificate sign request and uses for example the CMPv2 protocol to request the certificate and uses the OTP as proof that it is the correct VNF node 200. The certificate sign request may contain the identifier in the request to be included in the issued certificate using a certificate extension, for example, as a uniform resource indicator (URI) in the subjectAltName extension or pseudonym of a X.509 v3 certificate. Alternatively, the certificate registration authority node 500, knowing the identifier, can also force the identifier to be written into an extension regardless of the certificate sign request (CSR) content. The exact behavior of the certificate registration authority node 500 is at the discretion of the certificate registration authority node 500, often formulated as a policy. Hence, the identifier that goes into the issued certificate will originate from the TEE 240 and have passed an attest verification procedure. This will prevent the application 250 in the VNF node 200 to conjure up an instance of its own making and also will prevent the orchestration to enforce an external identifier (purposely or by mistake).

While in the above the secure identifier creation process has been described as a dedicate process on its own, there can be alternative implementation where the process is integrated with an attestation process that covers other aspects and properties of the TEE 240.

The security of the interactions of the certificate broker node 300 and the VNF node 200 can be augmented to protect the provisioning of the OTP to the VNF node 200 by encrypting the OTP with a key in the TEE 240. For example, if the identity key in the TEE 240 also supports encryption, the certificate broker node 300 can encrypt the OTP with the public key of the identity key in the TEE 240.

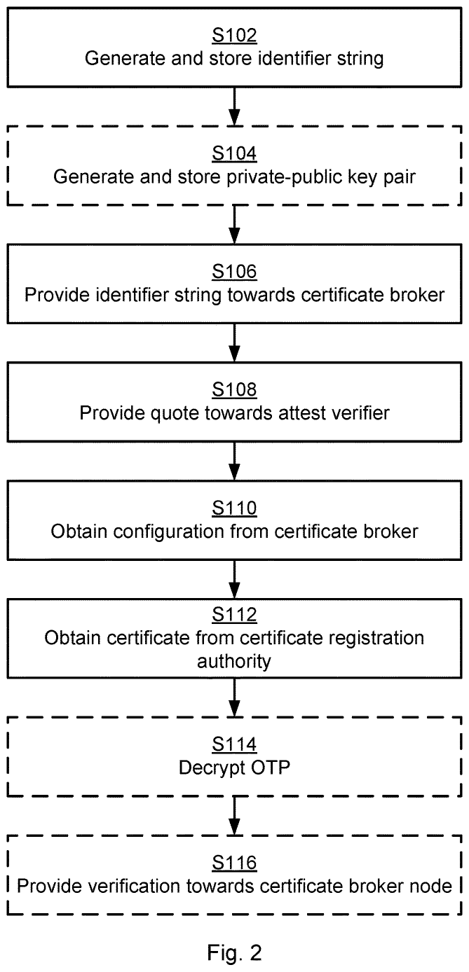

Reference is now made to FIG. 2 illustrating a method for a VNF node 200 to obtain a certificate according to an embodiment.

S102: The VNF node 200 generates and stores an identifier string of the VNF node 200 inside a TEE of the VNF node 200.

S106: The VNF node 200 provides the identifier string towards a certificate broker node 300.

It is then assumed that the VNF node 200 in return obtains a session value from an attest verifier node 400, as in step S108.

S108: The VNF node 200 provides a quote towards an attest verifier node 400 upon having obtained a session value from the attest verifier node 400. The quote is based on the session value and comprises the identifier string or a hash of the identifier string.

It is then assumed that the VNF node 200 in return obtains configuration from the certificate broker node 300, as in step S110.

S110: The VNF node 200 obtains configuration from the certificate broker node 300 for enrollment of the certificate with a certificate registration authority node 500.

The VNF node 200 then interacts with the certificate registration authority node 500 for receiving the certificate, as in step S112.

S112: The VNF node 200 obtains the certificate from the certificate registration authority node 500 in accordance with the configuration.

Embodiments relating to further details for the VNF node 200 to obtain the certificate will now be disclosed.

In some examples, the identifier string is generated and stored upon the VNF node 200 being started for the first time. Hence, in some embodiments, the identifier string is created and stored in response to the VNF node 200 being initialized.

In some embodiments, the identifier string, or a hash of the identifier string, is provided to the certificate registration authority node 500 as part of the VNF node 200 enrolling with the certificate registration authority node 500.

The VNF node 200 might inform the certificate broker node 300 that the VNF node 200 has received the certificate. Hence, in some embodiments, the VNF node 200 is configured to perform (optional) step S116.

S116: The VNF node 200 provides a verification towards the certificate broker node 300 that the VNF node 200 has received the certificate.

A private-public key pair might be generated and stored in the TEE 240 for different purposes as will be disclosed below. Hence, in some embodiments, the VNF node 200 is configured to perform (optional) step S104.

S104: The VNF node 200 generates and stores a private-public key pair in the TEE.

In some embodiments, the public key of the private-public key pair is provided in the quote.

In some embodiments, the certificate is obtained using a one-time password that was encrypted with a public key of the private-public key pair, and the VNF node 200 is configured to perform (optional) step S114.

S114: The VNF node 200 decrypts the one-time password using a private key of the private-public key pair.

In some embodiments, the private-public key pair is to be used as birth credential for the VNF node 200.

In some embodiments, a hash of a public key of the private-public key pair is provided in the quote.

Reference is now made to FIG. 3 illustrating a method for assigning a certificate to a VNF node 200 as performed by the certificate broker node 300 according to an embodiment.

As disclosed above, the VNF node 200 provides an identifier string towards the certificate broker node 300. It is assumed that this identifier string is received by the certificate broker node 300, as in step S202.

S202: The certificate broker node 300 obtains an identifier string of the VNF node 200 from the VNF node 200.

Reception of the identifier string triggers attestation of the VNF node 200. The certificate broker node 300 therefore performs step S204.

S204: The certificate broker node 300 initiates attestation of the VNF node 200 by sending the identifier string to an attest verifier node 400 and requesting the attest verifier node 400 to send a session value towards the VNF node 200.

It is next assumed that the attestation of the VNF node 200 is successful and that the certificate broker node 300 is made aware of this, as in step S206.

S206: The certificate broker node 300 obtains an indication of successful attestation of the VNF node 200 from the attest verifier node 400.

A certificate for the VNF node 200 is then requested, as in step S208.

S208: The certificate broker node 300 requests the certificate for the VNF node 200 by registering the VNF node 200 with a certificate registration authority node 500.

The VNF node 200 can then be configured for enrollment of the certificate, as in step S210.

S210: The certificate broker node 300 provides the VNF node 200 with configuration for enrollment of the certificate.

Embodiments relating to further details of assigning a certificate to a VNF node 200 as performed by the certificate broker node 300 will now be disclosed.

As disclosed above, in some examples, the identifier string is generated and stored upon the VNF node 200 being started for the first time. Therefore, in some embodiments, obtaining the identifier string in step S202 indicates to the certificate broker node 300 that the VNF node 200 has been initialized.

In some embodiments, the identifier string is by the certificate broker node 300 provided to the certificate registration authority node 500 when the certificate broker node 300 requests the certificate for the VNF node 200.

As disclosed above, the VNF node 200 might inform the certificate broker node 300 that the VNF node 200 has received the certificate. Hence, in some embodiments, the certificate broker node 300 is configured to perform (optional) step S212.

S212: The certificate broker node 300 obtains a verification from the VNF node 200 that the VNF node 200 has received the certificate.

In some embodiments, the indication from the attest verifier node 400 is accompanied with a public key of a private-public key pair of the VNF node 200.

In some embodiments, registering the VNF node 200 with the certificate registration authority node 500 comprises providing a one-time password as encrypted with the public key to the certificate registration authority node 500.

In some embodiments, the private-public key pair is to be used as birth credential for the VNF node 200. Registering the VNF node 200 with the certificate registration authority node 500 might then comprise providing the public key to the certificate registration authority node 500 upon the certificate broker node 300 having received verification from the attest verifier node 400 that the public key is bound to the VNF node 200.

In this way the certificate broker node 300 may use the attest verifier node 400 to assess that the public key of the birth credential is indeed bound to the VNF node 200 and after successful assessment will give the public key of the birth credential to the certificate registration authority node 500 during the registration. The birth credential can thus be used in the VNF node 200 when performing actions according to a certificate enrollment protocol to prove that the VNF node 200 is the rightful requester/claimer of the certificate.

In some examples, the identifier string is a network function instance identifier (nfInstanceID). In some examples, the identifier string is a value assigned by the certificate broker. The identifier string may be included in any filed of the certificate request and certificate, such as a Distinguished Name (DN) part, subject alternative name (SAN) or extension, as a pseudonym.

In some examples, the attest verifier node 400 is located inside the certificate registration authority node 500, and for example is part of registration authority functionality.

In some examples, the enrolment protocol used is any of: CMPv2, EST, ACME using external account binding. In some examples, the enrolment protocol used can be something else, or proprietary, fulfilling the account provisioning used by the certificate broker.

In some examples, the certificate broker node 300 provides OTPs as encrypted blob using a key inside TEE 240. In case the AttestSignKey is used for this purpose, then the certificate broker node 300 can obtain the public portion of that key from the attest verifier node 400. However, via the attest procedures, also other keys and trust relations between the TEE 240 and the attest verifier node 400 or certificate broker node 300 can be put in place for the purpose of OTP encryption.

The VNF node 200 may know the existence and addresses of other VNF nodes 200 it wants, or needs, to interact with through orchestration. In practice, such as in a 3GPP 5G cellular communication systems, the VNFs (called NFs) will find their services by a repository service implemented in a dedicated VNF, called an NRF. Since the certificate broker node 300 and the attest verifier node 400 have knowledge of which VNFs are intended to be in a complete system, such as a 5G cellular communication network, the certificate broker node 300 or the attest verifier node 400 might be operatively connected to the 5G NRF. In that way, certificate lifecycle operations can be initiated from the VNF related actions in the NRF and not only from the orchestration, and the NRF can used the information of the certificate broker node 300 or attest verifier node 400 to only register VNF services that have been vetted by the attest verifier node 400. In some examples, a 3GPP NRF is configured to use information from the certificate broker node 300 and the attest verifier node 400 to secure that registered VNF nodes 200 have been verified and/or are still active members in the PKI of the certificate registration authority node 500. In some examples, a 3GPP NRF is configured to send events of VNF nodes 200 to the certificate broker node 300.

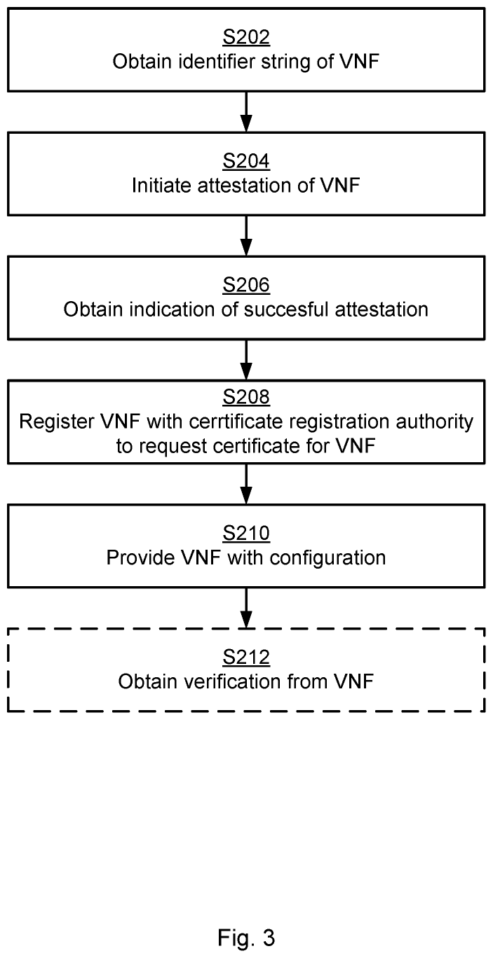

Reference is next made to the block diagram 100b of FIG. 4.

The VNF node 200 is started and the application 250 triggers an identifier creator (IdentifierCreator) block 242 inside the TEE 240 to generate an identifier string. The identifier string is then securely stored in the TEE 240, and thereby protected against modifications. The VNF 200 sends a signal to the certificate broker (certBroker) node 300 that the VNF node 200 has completed initialization. The VNF node 200 also sends the identifier string to the certificate broker node 300. The certificate broker node 300 initiates attestation of the VNF node 200 by sending the identifier string to the attest verifier (AttestVerifier) node 400 and requesting the attest verifier node 400 to send a session value towards the VNF node 200. The attest verifier node 400 creates a session value (such as a random value or a nonce value) and sends the session value towards the attest engine (AttestEngine) block 243 in the TEE 240. The attest engine block 243 computes a quote. The quote is based on the session value and comprises the identifier string or a hash of the identifier string. The quote is signed by a key provided by an attest signing key (AttestSignKey) block 244. The attest signing key block 244 might further be to provide a hardware identity key for the TEE 240 or to facilitate encryption by its public portion and decryption inside the TEE 240 by the private portion. The VNF node 200 sends the quote to the attest verifier node 400. The quote is by the attest verifier 400 validated by the attest verifier 400 checking the quote against a pre-provisioned allowed list (e.g., containing allowed values according to the configuration of the VNF node 200, according to the hardware of the TEE 240, etc.) and checks the identifier string the attest verifier 400 may have received earlier. When the quote checks, the identifier string is declared valid. Otherwise, the identifier string is declared not trusted for further use. As an alternative, the identifier string might be included in the certificate sign request (CSR) that is passed to the certificate registration authority node 500 as part of the enrollment procedure between the VNF node 200 and the certificate registration authority (CA/RA) node 500. The certificate registration authority node 500 might then either use the identifier string provided at the registration or allow the identifier string to be provided as part of the CSR and only check if the value provided with the CSR matches the one provided earlier. In the latter case, the actual value of the identifier string needs not to be provided at registration but only a hash of the identifier string. The attest verifier node 400 provides an indication of successful attestation of the VNF node 200 to the certificate broker node 300. The certificate broker node 300 registers the VNF node 200 with the certificate registration authority node 500 and thereby requests a certificate for the VNF node 200. The certificate broker node 300 provides the VNF node 200 with configuration for enrollment of the certificate with the certificate registration authority node 500. The VNF node 200 obtains the certificate from the certificate registration authority node 500 in accordance with the configuration and provides a verification towards the certificate broker node 300 that the VNF node 200 has received the certificate.

Reference is next made to the block diagram 100c of FIG. 5, which shows an alternative where OTPs are used. The TEE 240 informs the attest verifier node 400, e.g., using the quote, of the public key to be used to encrypt the OTP (or registration credential). For example, the key might be the key used to sign the quote, but it could also be another key generated in the TEE 240.

The certificate broker node 300 registers the VNF node 200 with the certificate registration authority node 500 and receives from (or agrees with) the certificate registration authority node 500 an OTP, or registration credential, to be used in the enrollment protocol to get a certificate for the VNF node 200. The certificate broker node 300 configures the VNF node 200 for certificate management enrollment and sends to the VNF node 200 the OTP encrypted with the public key. The application 250 uses the TEE 240 to decrypt the OTP and uses the decrypted OTP in the subsequent enrollment procedure according to the certificate management protocol. In order to do so, in addition to the identifier string, a private-public key pair is generated and stored in the TEE 240. The attestation engine 243 includes the public portion of the private-public key pair as part of the attestation with the attest verifier node 400. The attest verifier node 400 then extracts the public key from the quote. The certificate broker node 300 receives the public key and when the OTP is agreed with certificate registration authority node 500 as part of the registration, the OTP is encrypted with the public key. This encryption might use a random value to prevent replay attacks. For example, the session value can be used as the random value. The application 250 passes the received encrypted OTP to the TEE 240 for decryption. Then, the recovered OTP can be used when executing steps of the certificate management protocol.

Reference is next made to the block diagram 100d of FIG. 6. The block diagram 100c can be regarded as an alternative to the block diagram 100b, where instead a birth credential is used instead of a OTPs, where the private portion of the birth credential is generated and kept in the TEE 240. Certificate management protocols such as CPMV2 allow the use of so-called birth credentials. According to the present disclosure, such a birth credential is generated on-the-fly and is through the attestation procedure bound to the TEE 240, and thus to the VNF node 200.

In particular, in addition to the identifier string being generated, also a private-public key pair is generated and stored in the TEE 240. As disclosed above, this private-public key pair can be used as birth credential. A certificate can be created to hold the public key of the private-public key pair. But, for simplicity and without loss of generality, the procedure is described without using such a certificate. The public key is sent as part of the ready message to the certificate broker node 300. Further, the attestation engine 243 includes the hash of the public portion of the birth credential as part of the attestation with the attest verifier node 400. The attest verifier node 400 then extracts the hash of the public key from quote and compares this hash with the hash of the received public key. As part of the registration, the certificate broker node 300 passes the public key of the birth credential to certificate registration authority node 500.

In FIG. 5 and FIG. 6 is illustrated that an implementation can either use the quote to send data, such as the public key, to the certificate broker node 300 (via the attest verifier node 400) or that this data can be sent explicitly from the application 250 to the certificate broker node 300 and have its value authenticated by including a hash of the data in the quote.

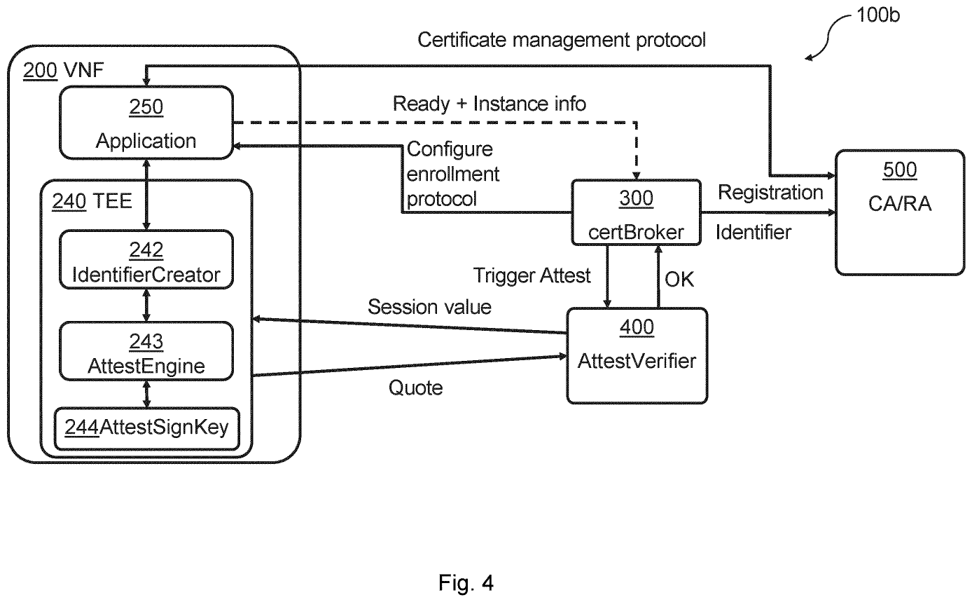

Reference is next made to FIG. 7 in which is provided a signaling diagram for a method based on at least some of the embodiments disclosed above. The description shows the steps by which an entity in the VNF node receives an end-entity certificate. The individual steps are only indicative and thus two or more individual steps might be combined into one combined steps, if suitable, etc.

In FIG. 7 a certificate management (CM) proxy is provided as a bridge and to facilitate the initial trust establishment between the VNF node and the CA/RA node without having impact on the CA/RA node. The functionality of the CM proxy can be implemented by the certificate broker node. How to perform and use attestation and as well as trusted execution is out of scope of this disclosure.

S301: The VNF node is successfully instantiated. One way to achieve this is to use day-o configuration. The day-o configuration might include the initial credential and trust anchors (e.g. root certificate) to be used by VNF node to establish a secure communication channel initiated from the CM proxy. For example, if TLS is used as a secure communication channel between the VNF node and the CM proxy, the VNF node can be pre provisioned with a TLS server certificate which is signed by a root certificate that is stored in the CM proxy. The initial credential, such as one time secret can be pre-provisioned for authentication between the CM proxy and the VNF node through day-o configuration of the VNF node and the CM proxy. The initial credential, such as one time secret can be pre-provisioned for authentication between the CA/RA node and the VNF node through day-o configuration of the CM proxy or the CA/RA node. The initial credential is used by the CA/RA node to authenticate the VNF node. One way to implement S301 is to perform S102, S104, S202.

S302: (Optional when attestation is in use) To enhance the trustworthiness of the VNF node, the VNF node instance is attested. Attestation results can be maintained by an Attestation Verifier for subsequent access. One way to implement S302 is to perform S106, S106, S204, S206.

S303: The CM proxy is provisioned through OAM procedure with necessary information. The necessary information might comprise initial credential to be used by the CM proxy node to set up a secure communication channel with the VNF node. For example, if TLS is used as a secure communication channel between the VNF node and the CM proxy, the CM proxy can verify the TLS server certificate of the VNF node using a preconfigured root certificate in the CM proxy. The necessary information might further comprise the VNF identities (e.g., FQDNs to be presented in the certificate).

S304: (Optional when attestation is in use) The CM proxy acting as relying party can verify the VNF node based on the attestation result and decide whether the VNF is eligible for certification or not. One way to implement S304 is to perform S106 (in combination with providing a hash/session value), S206.

S305: The CM proxy registers the VNF node end-entity to the CA/RA node. The identities of the VNF node end-entity (obtained from previous steps) can be registered to the CA/RA node. One way to implement S305 is to perform S208.

S306: The CA/RA node provides authentication credentials to the CM proxy. The authentication credentials might depend on the agreement with the CA/RA node. As an example, the authentication credentials can be a one-time secret used by the CA/RA node to authenticate the received certificate signing request (CSR) associated with the registered VNF node identity in step S305. For example, an initial authentication key (IAK) can be agreed to be used in the enrolment protocol to get a certificate for the VNF node end-entity. The CA/RA node could then send the IAK as the authentication credentials to the CM proxy. One way to implement S306 is to perform S114.

S307: CM proxy provides the NF about enrolment information and authentication materials. The enrolment information might comprise information about the enrolment protocol, CA/RA node details, and registered VNF identities in step S205. The information sent from the CM proxy should be protected. For example, TLS can be used as a transport layer protection between the VNF and the CM proxy. One way to implement S307 is to perform S110 and S210.

S308: The VNF node generates a key pair and prepares a Certificate Signing Request (CSR) message.

S309: The VNF node sends the certificate enrolment request to the CA/RA node. Authentication credentials received in step S307 can be used to authenticate the origin of the CSR from the VNF node end-entity to the CA/RA node. The VNF node can authenticate the CA/RA based on out-of-band means. For example, the CA/RA's root certificate can be pre-configured as trust anchor in the VNF node, or be installed as part of step S307.

S310: The CA/RA node returns the issued certificate to the VNF node. The CA/RA node can validate the certificate enrolment request based on local policies using the identities received in step S305.

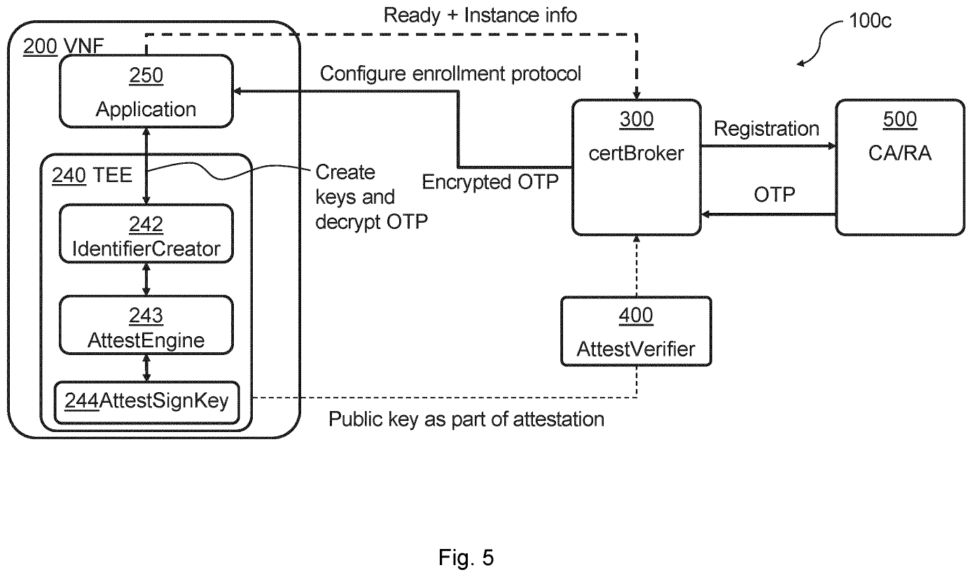

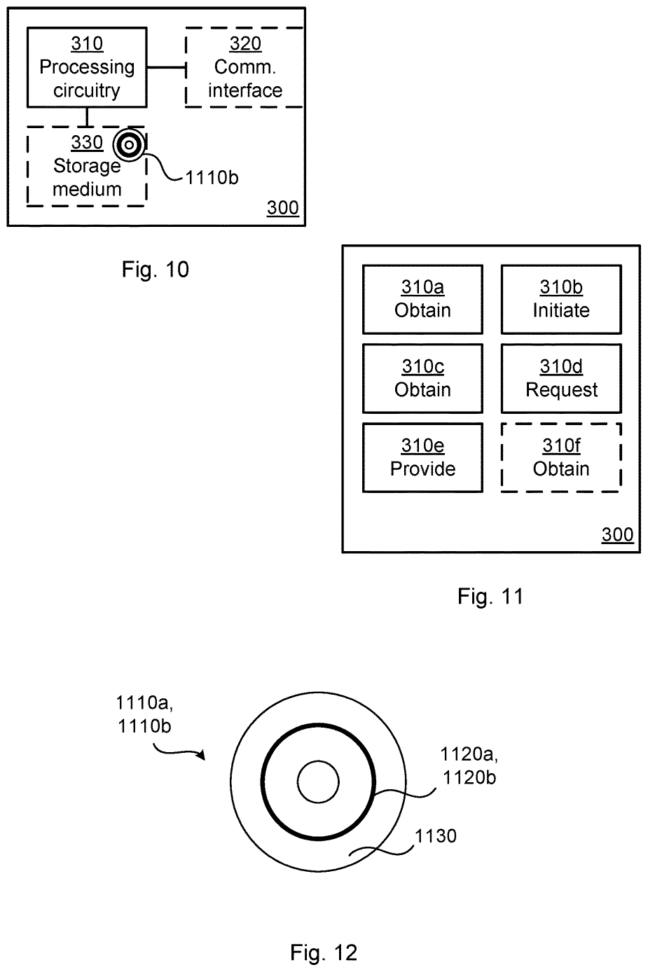

FIG. 8 schematically illustrates, in terms of a number of functional units, the components of a VNF node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1110a (as in FIG. 12), e.g. in the form of a storage medium 230. The processing circuitry 210 may further be provided as at least one application specific integrated circuit (ASIC), or field programmable gate array (FPGA).

Particularly, the processing circuitry 210 is configured to cause the VNF node 200 to perform a set of operations, or steps, as disclosed above. For example, the storage medium 230 may store the set of operations, and the processing circuitry 210 may be configured to retrieve the set of operations from the storage medium 230 to cause the VNF node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The VNF node 200 may further comprise a communications interface 220 for communications with other entities, functions, nodes, and devices, as disclosed above. As such the communications interface 220 may comprise one or more transmitters and receivers, comprising analogue and digital components.

The processing circuitry 210 controls the general operation of the VNF node 200 e.g. by sending data and control signals to the communications interface 220 and the storage medium 230, by receiving data and reports from the communications interface 220, and by retrieving data and instructions from the storage medium 230. Other components, as well as the related functionality, of the VNF node 200 are omitted in order not to obscure the concepts presented herein.

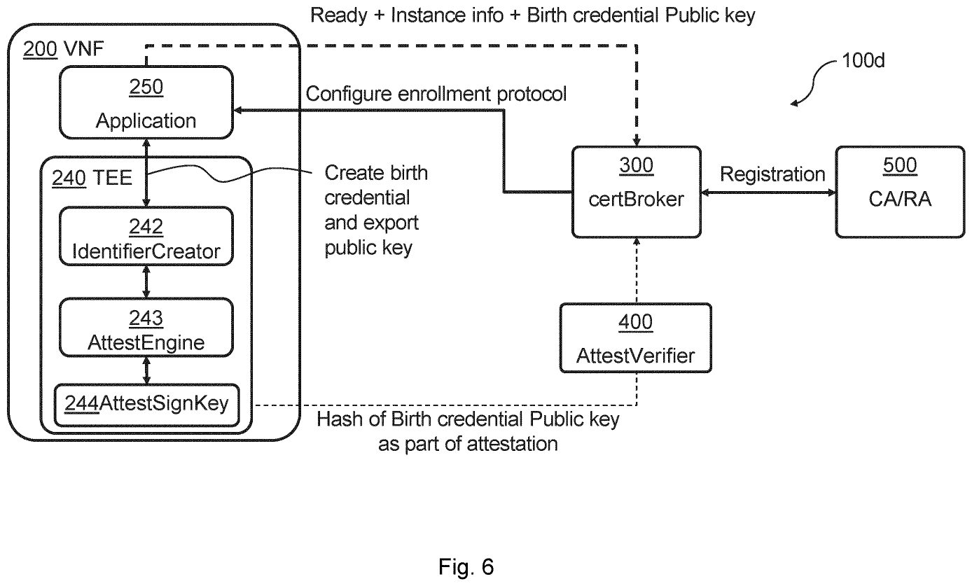

FIG. 9 schematically illustrates, in terms of a number of functional modules, the components of a VNF node 200 according to an embodiment. The VNF node 200 of FIG. 9 comprises a number of functional modules; a generate and store module 210a configured to perform step S102, a provide module 210c configured to perform step S106, a provide module 210d configured to perform step S108, an obtain module 210e configured to perform step S110, and an obtain module 210f configured to perform step S112. The VNF node 200 of FIG. 9 may further comprise a number of optional functional module 210s, such as any of a generate and store module 210b configured to perform step S104, a decrypt module 210g configured to perform step S114, and a provide module 210h configured to perform step S116.

In general terms, each functional module 210a:210h may be implemented in hardware or in software. Preferably, one or more or all functional modules 210a:210h may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210h and to execute these instructions, thereby performing any steps of the VNF node 200 as disclosed herein.

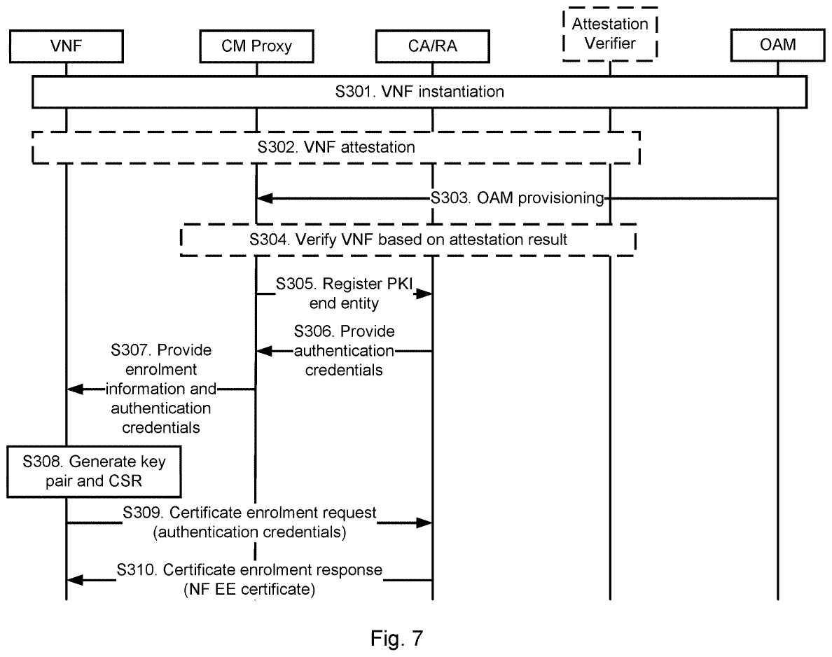

FIG. 10 schematically illustrates, in terms of a number of functional units, the components of a certificate broker node 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1110b (as in FIG. 12), e.g. in the form of a storage medium 330. The processing circuitry 310 may further be provided as at least one application specific integrated circuit (ASIC), or field programmable gate array (FPGA).

Particularly, the processing circuitry 310 is configured to cause the certificate broker node 300 to perform a set of operations, or steps, as disclosed above. For example, the storage medium 330 may store the set of operations, and the processing circuitry 310 may be configured to retrieve the set of operations from the storage medium 330 to cause the certificate broker node 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The certificate broker node 300 may further comprise a communications interface 320 for communications with other entities, functions, nodes, and devices, as disclosed above. As such the communications interface 320 may comprise one or more transmitters and receivers, comprising analogue and digital components.

The processing circuitry 310 controls the general operation of the certificate broker node 300 e.g. by sending data and control signals to the communications interface 320 and the storage medium 330, by receiving data and reports from the communications interface 320, and by retrieving data and instructions from the storage medium 330. Other components, as well as the related functionality, of the certificate broker node 300 are omitted in order not to obscure the concepts presented herein.

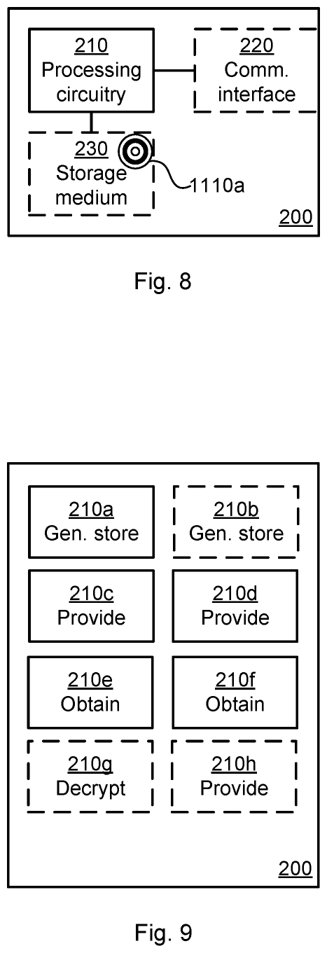

FIG. 11 schematically illustrates, in terms of a number of functional modules, the components of a certificate broker node 300 according to an embodiment. The certificate broker node 300 of FIG. 11 comprises a number of functional modules; an obtain module 310a configured to perform step S202, an initiate module 310b configured to perform step S204, an obtain module 310c configured to perform step S206, a request module 310d configured to perform step S208, and a provide module 310e configured to perform step S210.

The certificate broker node 300 of FIG. 11 may further comprise a number of optional functional modules, such as an obtain module 310f configured to perform step S212. In general terms, each functional module 310a:310f may be implemented in hardware or in software. Preferably, one or more or all functional modules 310a: 310f may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310f and to execute these instructions, thereby performing any steps of the certificate broker node 300 as disclosed herein.

Each node 200, 300, 400, 500 may be provided as a standalone device or as a part of at least one further device. For example, at least some of the nodes 200, 300, 400, 500 may be provided in a core network. Alternatively, the functionality of each of the nodes 200, 300, 400, 500 may be distributed between at least two devices, or nodes. These at least two nodes, or devices, may either be part of the same network part or may be spread between at least two such network parts.

Thus, a respective first portion of the instructions performed by each of the nodes 200, 300, 400, 500 may be executed in a respective first device, and a respective second portion of the instructions performed by each of the nodes 200, 300, 400, 500 may be executed in a respective second device; the herein disclosed embodiments are not limited to any particular number of devices on which the instructions performed by the nodes 200, 300, 400, 500 may be executed. Hence, the methods according to the herein disclosed embodiments are suitable to be performed by nodes 200, 300, 400, 500 residing in a cloud computational environment. Therefore, although a single processing circuitry 210, 310 is illustrated in FIGS. 7 and 9 the processing circuitry 210, 310 may be distributed among a plurality of devices, or nodes. The same applies to the functional modules 210a:210h, 310a:310f of FIGS. 8 and 10 and the computer programs 1120a, 1120b of FIG. 12.

FIG. 12 shows one example of a computer program product 1110a, 1110b comprising computer readable means 1130. On this computer readable means 1130, a computer program 1120a can be stored, which computer program 1120a can cause the processing circuitry 210 and thereto operatively coupled entities and devices, such as the communications interface 220 and the storage medium 230, to execute methods according to embodiments described herein. The computer program 1120a and/or computer program product 1110a may thus provide means for performing any steps of the VNF node 200 as herein disclosed. On this computer readable means 1130, a computer program 1120b can be stored, which computer program 1120b can cause the processing circuitry 310 and thereto operatively coupled entities and devices, such as the communications interface 320 and the storage medium 330, to execute methods according to embodiments described herein. The computer program 1120b and/or computer program product 1110b may thus provide means for performing any steps of the certificate broker node 300 as herein disclosed.

In the example of FIG. 12, the computer program product 1110a, 1110b is illustrated as an optical disc, such as a CD (compact disc) or a DVD (digital versatile disc) or a Blu-Ray disc. The computer program product 1110a, 1110b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1120a, 1120b is here schematically shown as a track on the depicted optical disk, the computer program 1120a, 1120b can be stored in any way which is suitable for the computer program product 1110a, 1110b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for a virtual network function, VNF, node to obtain a certificate, the method being performed by the VNF node, the method comprising:
generating and storing an identifier string of the VNF node inside a trusted execution environment, TEE, of the VNF node;
providing the identifier string towards a certificate broker node;
providing a quote towards an attest verifier node upon having obtained a session value from the attest verifier node, wherein the quote is based on the session value and comprises the identifier string or a hash of the identifier string;
obtaining configuration from the certificate broker node for enrollment of the certificate with a certificate registration authority node; and
obtaining the certificate from the certificate registration authority node in accordance with the configuration.

2. The method according to claim 1, wherein the identifier string is created and stored in response to the VNF node being initialized.

3. The method according to claim 1, wherein the identifier string, or a hash of the identifier string, is provided to the certificate registration authority node as part of the VNF node enrolling with the certificate registration authority node.

4. The method according to claim 1, wherein the method further comprises:
providing a verification towards the certificate broker node that the VNF node has received the certificate.

5. The method according to claim 1, wherein the method further comprises:
generating and storing a private-public key pair in the TEE.

6. The method according to claim 5, wherein a public key of the private-public key pair is provided in the quote.

7. The method according to claim 5, wherein the certificate is obtained using a one-time password that was encrypted with a public key of the private-public key pair, and wherein the method further comprises:
decrypting the one-time password using a private key of the private-public key pair.

8. The method according to claim 5, wherein the private-public key pair is to be used as birth credential for the VNF node.

9. The method according to claim 8, wherein a hash of a public key of the private-public key pair is provided in the quote.

10. A method for assigning a certificate to a virtual network function, VNF, node, the method being performed by a certificate broker node, the method comprising:
obtaining an identifier string of the VNF node from the VNF node;
initiating attestation of the VNF node by sending the identifier string to an attest verifier node and requesting the attest verifier node to send a session value towards the VNF node;
obtaining an indication of successful attestation of the VNF node from the attest verifier node;
requesting the certificate for the VNF node by registering the VNF node with a certificate registration authority node; and
providing the VNF node with configuration for enrollment of the certificate.

11. The method according to claim 10, wherein obtaining the identifier string indicates that the VNF node has been initialized.

12. The method according to claim 10, wherein the identifier string is provided to the certificate registration authority node when requesting the certificate for the VNF node.

13. The method according to claim 10, wherein the method further comprises:
obtaining a verification from the VNF node that the VNF node has received the certificate.

14. The method according to claim 10, wherein the indication from the attest verifier node is accompanied with a public key of a private-public key pair of the VNF node (200).

15. The method according to claim 14, wherein registering the VNF node with the certificate registration authority node comprises providing a one-time password as encrypted with the public key to the certificate registration authority node.

16. The method according to claim 14, wherein the private-public key pair is to be used as birth credential for the VNF node, and wherein registering the VNF node with the certificate registration authority node comprises providing the public key to the certificate registration authority node upon the certificate broker node having received verification from the attest verifier node that the public key is bound to the VNF node.

17. A virtual network function, VNF, node for obtaining a certificate, the VNF node comprising processing circuitry, the processing circuitry being configured to cause th-16e VNF node to:
generate and store an identifier string of the VNF node inside a trusted execution environment, TEE, of the VNF node;
provide the identifier string towards a certificate broker node;
provide a quote towards an attest verifier node upon having obtained a session value from the attest verifier node, wherein the quote is based on the session value and comprises the identifier string or a hash of the identifier string;
obtain configuration from the certificate broker node for enrollment of the certificate with a certificate registration authority node; and
obtain the certificate from the certificate registration authority node in accordance with the configuration.

18-19. (canceled)

20. A certificate broker node for assigning a certificate to a virtual network function, VNF, node, the certificate broker node comprising processing circuitry, the processing circuitry being configured to cause the certificate broker node to:
obtain an identifier string of the VNF node from the VNF node;
initiate attestation of the VNF node by sending the identifier string to an attest verifier node and requesting the attest verifier node to send a session value towards the VNF node;
obtain an indication of successful attestation of the VNF node from the attest verifier node;
request the certificate for the VNF node by registering the VNF node with a certificate registration authority node; and
provide the VNF node with configuration for enrollment of the certificate.

21-25. (canceled)

26. The VNF node according to claim 17, wherein the identifier string is created and stored in response to the VNF node being initialized.

27. The VNF according to claim 17, wherein the identifier string, or a hash of the identifier string, is provided to the certificate registration authority node as part of the VNF node enrolling with the certificate registration authority node.

28. The VNF according to claim 17, further being configured to perform operations comprising:
providing a verification towards the certificate broker node that the VNF node has received the certificate.

29. The certificate broker node according to claim 20, wherein obtaining the identifier string indicates that the VNF node has been initialized.

30. The certificate broker node according to claim 20, wherein the identifier string is provided to the certificate registration authority node when requesting the certificate for the VNF node.

31. certificate broker node according to claim 20, further being configured to perform operations comprising:
obtaining a verification from the VNF node that the VNF node has received the certificate.
